(19) United States
(12) Patent Application Publication
(10) Pub. No.: US 2008/0261524 A1
(43) Pub. Date: Oct. 23, 2008

(54) Method and System for a Bluetooth Device That Supports Multiple Connections

(76) Inventor: Asif Grushkevich, LaJolla, CA (US)

Correspondence Address: MCANDREWS HELD & MALLOY, LTD, 500 WEST MADISON STREET, SUITE 3400, CHICAGO, IL, 60661, US

(21) Appl. No.: 11/737,514

(22) Filed: Apr. 19, 2007

(51) Int. Cl. H04M 1/56

(52) U.S. Cl. 455/41.2

(57) ABSTRACT

Methods and systems for a Bluetooth device that supports multiple connections are disclosed. Aspects of one method may include enabling an active Bluetooth device to generate an indication of an incoming call via a second of a plurality of Bluetooth devices when the Bluetooth enabled device is engaged in an existing call via a first of the plurality of Bluetooth devices. The indication may be an audible indication, a visible indication, and/or vibratory indication. A user of the active Bluetooth device may then decide whether to accept the incoming call, and may place the existing call on hold. The active Bluetooth device may also be used to initiate an outgoing call via another one of the plurality of Bluetooth devices, when the active Bluetooth device is engaged in the existing call via the first Bluetooth device.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to wireless communication. More specifically, certain embodiments of the invention relate to a method and system for a Bluetooth device that supports multiple connections.

### BACKGROUND OF THE INVENTION

With the popularity of portable electronic devices and wireless devices that support various applications, there is a growing need to provide accessibility to various types of devices. One development is the Bluetooth standard that allows wireless personal area networks, also referred to as piconets, to be created as needed. Bluetooth provides a way to connect and exchange information between devices such as mobile phones, laptops, PCs, printers, digital cameras, and video game consoles over a secure, globally unlicensed short-range radio frequency.

Bluetooth is a radio standard and communications protocol primarily designed for low power consumption, with a short range (power-class-dependent: 1 meter, 10 meters, 100 meters) based on low-cost transceiver microchips in each device. Bluetooth lets these devices communicate with each other when they are in range. The devices use a radio communications system, so they do not have to be in line of sight of each other, and can even be in other rooms, so long as the received transmission is powerful enough.

A popular Bluetooth-enabled device is a hands-free headset for mobile communication. The Bluetooth-enabled hands-free headset allows a user to have a phone conversation by communicating audio data with other wireless devices in a piconet, such as, for example, mobile phones, PDAs, and/or PCs/laptops, while freeing the user to perform other activities. However, a drawback to a Bluetooth headset may be that when the user is using the headset, for example, for a telephone call, the user may not know of other applications that may be trying to communicate with the user via the Bluetooth headset. This may be, for example, because the Bluetooth protocol stack in the Bluetooth headset may ignore another incoming voice call if there is an existing voice call.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for a Bluetooth device that supports multiple connections, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of exemplary Bluetooth enabled mobile terminals for use with a hands-free Bluetooth headset, in accordance with an embodiment of the invention.

FIG. 2 is a block diagram illustrating an exemplary Bluetooth enabled headset, in accordance with an embodiment of the invention.

FIG. 3 is an exemplary flow diagram for supporting multiple connections, in accordance with an embodiment of the invention.

FIG. 4 is an exemplary flow diagram for initiating a call with one of a plurality of supported communication devices, in accordance with an embodiment of the invention.

FIG. 5 is an exemplary flow diagram for receiving a call via at least one of a plurality of supported communication devices, in accordance with an embodiment of the invention.

### DETAILED DESCRIPTION OF THE INVENTION

Certain embodiments of the invention may be found in a method and system for a Bluetooth device that supports multiple connections. Aspects of the method may comprise enabling an active Bluetooth device, such as, for example, a Bluetooth enabled headset, to receive notification of an incoming call via a second of a plurality of Bluetooth devices when the active Bluetooth device is engaged in an existing call via a first of the plurality of Bluetooth devices. The active Bluetooth device may then generate an indication representative of the received notification, where the generated indication may be an audible indication, a visible indication, and/or vibratory indication. The audible indication may be speech generated by the active Bluetooth device. The speech may, for example, depend on information communicated by the second Bluetooth device. A user of the active Bluetooth device may then decide whether to accept or decline the incoming call. If the call is accepted, the user may place the existing call on hold.

The active Bluetooth device may also be used to initiate an outgoing call via another one of the plurality of Bluetooth devices, when the active Bluetooth device is currently engaged in the existing call via the first Bluetooth device. The outgoing call may be placed via a default communication device, which may be automatically selected from one of the plurality of Bluetooth devices. The default communication device may be changed by selecting another one of the plurality of Bluetooth devices as the default communication device.

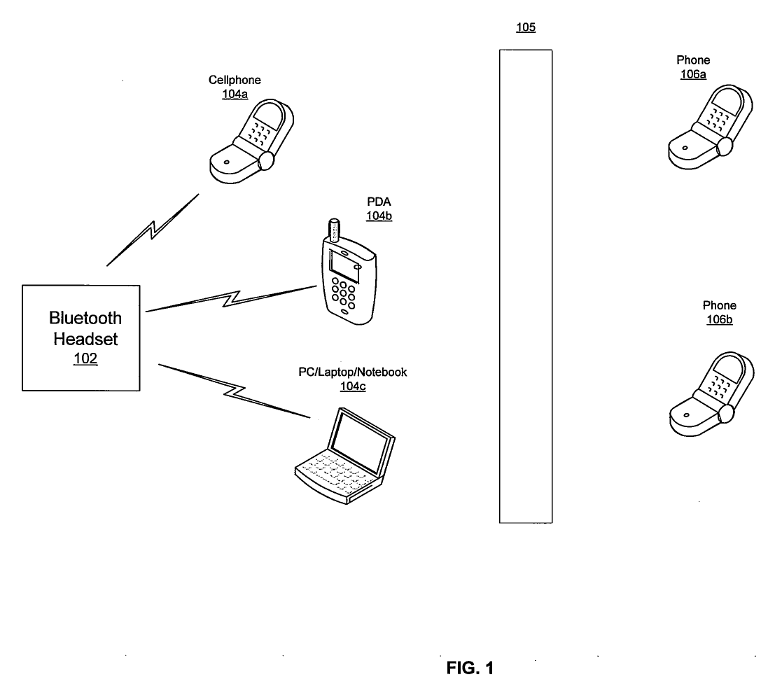

FIG. 1 is a block diagram of exemplary Bluetooth enabled mobile terminals for use with a hands-free Bluetooth headset, which may be utilized in accordance with an embodiment of the invention. Referring to FIG. 1, there is shown a Bluetooth enabled headset 102 and wireless communication devices 104a, 104b, 104c, such as, for example, a Bluetooth enabled cellular phone 104a, a Bluetooth enabled personal digital assistant (PDA) 104b, and a Bluetooth enabled computer 104c. There is also shown a communication network 105 and exemplary communication devices 106a and 106b.

The Bluetooth enabled headset 102 may enable a user to communicate with other Bluetooth enabled devices, such as, for example, the cellular phone 104a, the PDA 104b, and/or the computer 104c. Each of the cellular phone 104a, the PDA 104b, and the computer 104c may enable a user to communicate with other phone users via, for example, a circuit oriented or a packet oriented connection. The PDA 104b may comprise, for example, cellular phone functionality, wireless LAN functionality and/or VoIP phone capability. The computer 104c may allow voice communication with another person using a computer or a phone via, for example, an application program such as Skype. The computer 104c may be a desktop PC, laptop PC, notebook PC, or a tablet PC, for example.

The communication network 105 may comprise, for example, a cellular network and/or a telephone network that may allow communication for the communication devices 106a and 106b. The communication device 106a and/or 106b may be connected to each other or to other devices such as, for example, the cellular phone 104a, the PDA 104b, and/or the computer 104c.

In operation, the Bluetooth enabled headset 102 may be paired and synchronized with, for example, the Bluetooth enabled cellular phone 104a. Accordingly, the Bluetooth enabled headset 102 user's voice may be communicated to the Bluetooth enabled cellular phone 104a, which may then communicate voice signals via the communication network 105, which may comprise cellular and/or another type of network to the other party, for example, on the communication device 106a. Similarly, the voice signals from the other party on the communication device 106a may be received via the communication network 105 by the Bluetooth enabled cellular phone 104a, and the voice signals may be communicated to the Bluetooth enabled headset 102. Therefore, a user of the Bluetooth enabled headset 102 may carry on a conversation with another party without having to hold the Bluetooth enabled cellular phone 102.

In accordance with various embodiments of the invention, a Bluetooth enabled mobile terminal, for example the Bluetooth enabled headset 102, currently engaged in an existing call with, for example, the communication device 106a via the Bluetooth enabled cellular phone 104a, may be enabled to receive notification that there is an incoming call via another one of the wireless communication devices. For example, the Bluetooth enabled headset 102 may provide a notification that the PDA 104b may be receiving an incoming call from the communication device 106b.

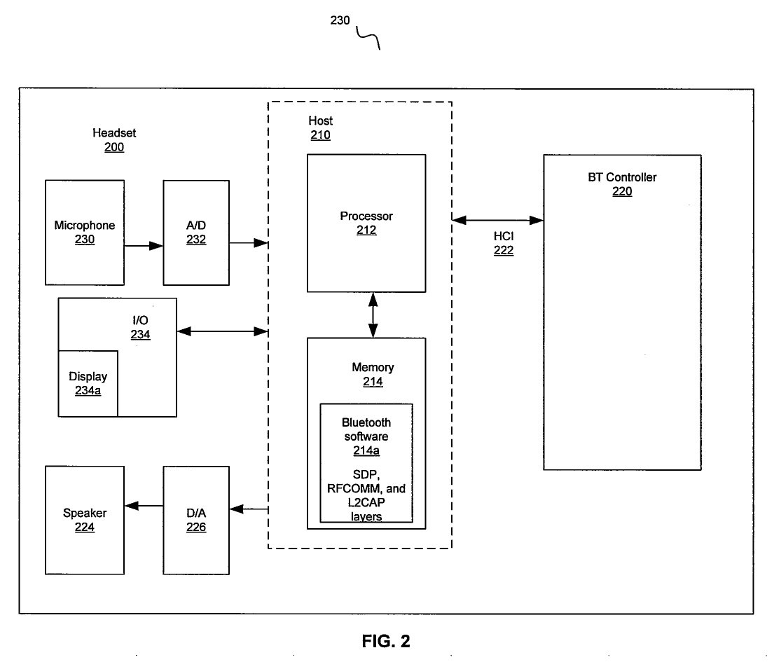

FIG. 2 is a block diagram illustrating an exemplary Bluetooth enabled headset, in accordance with an embodiment of the invention. Referring to FIG. 2, there is shown a Bluetooth enabled headset 200. The Bluetooth enabled headset 200 may be similar to the Bluetooth enabled headset 102, and may comprise a host 210, a Bluetooth controller 220, a host-controller interface (HCI) 222, a speaker 224, a digital-to-analog converter (DAC) 226, a microphone 230, an analog-to-digital converter (ADC) 232, and at least one user I/O device 234. The user I/O device 234 may comprise, for example, at least one button, a scroll wheel, and/or a display that may be used to input or output information. For example, a button may be used to select a device to be used for placing an outgoing call. The button may be a hardware button or a software enabled button. The display may be, for example, the display 234a that may display the name of a device that may be currently used and/or that may be selected for placing an outgoing call. The host 210 may comprise a processor 212 and memory 214. Bluetooth software 214a may be stored in the memory 214, where the Bluetooth software 214a may comprise at least some layers of Bluetooth protocol. The layers of Bluetooth protocol may comprise, for example, logical link control and adaptation protocol (L2CAP), RFCOMM protocol, and service discovery protocol (SDP).

The SDP layer may provide a means for applications to discover which services may be provided by or may be available through a Bluetooth device. It may also allow applications to determine the characteristics of those available services, such as, for example, a service class for a specific service. The RFCOMM protocol may provide emulation of RS232 serial ports over the L2CAP. For example, the RFCOMM may allow support of up to 60 simultaneous connections between two Bluetooth devices. The number of connections that may be used simultaneously in a Bluetooth device may be implementation-specific. With respect to RFCOMM, a complete communication path may involve two applications running on different devices (the communication endpoints) with a communication segment between them. The RFCOMM protocol may accommodate different types of Bluetooth devices. Type 1 devices may be communication end points such as computers and printers. Type 2 devices may be those that are part of the communication segment, such as, for example, modems.

The L2CAP layer supports higher-level protocol multiplexing, packet segmentation and reassembly, and the conveying of quality of service information. Accordingly, the L2CAP layer provides connection-oriented and connectionless data services to upper layer protocols with protocol multiplexing capability, segmentation and reassembly operation, and group abstractions. The L2CAP layer may permit higher-level protocols and applications to transmit and receive L2CAP data packets, where each packet may be up to 64 kilobytes in length.

The processor 212 may comprise suitable logic, circuitry, and/or code that may enable control and/or management operations in at least portions of the Bluetooth enabled headset 200. In this regard, the processor 212 may communicate control and/or management operations to the host 210 and the Bluetooth controller 220. Moreover, the processor 212 may be utilized to process data received by the Bluetooth enabled headset 200 and/or to process data to be transmitted by the Bluetooth enabled headset 200.

The memory 214 may comprise suitable logic, circuitry, and/or code that may enable storing of data and/or code, and reading of the stored data and/or code. For example, the Bluetooth software 214a may be stored in the memory 214. The Bluetooth software 214a may be executed by the processor 212 to process the data received from the Bluetooth controller 220. The Bluetooth software 214a may also be used to process data that may be communicated to the Bluetooth controller 220, which may then transmit the data to other Bluetooth devices.

The Bluetooth controller 220 may comprise suitable logic, circuitry, and/or code that may enable Bluetooth transmission of data to other Bluetooth devices and reception of Bluetooth transmission from other Bluetooth devices. The Bluetooth controller 220 may also enable communication of data to and from the host 210. The Bluetooth controller 220 may comprise lower layers of the Bluetooth protocol, such as, for example, link manager protocol (LMP) layer, baseband layer, and the radio layer. A link manager on each Bluetooth device may use the LMP to set up and control communication links. For example, the LMP may communicate with other Bluetooth devices and receive their names. These names may be displayed, for example, on the display 234a.

The baseband layer is the physical layer of the Bluetooth protocol that may be used to manage physical channels and links apart from other services like error correction, data whitening, hop selection and Bluetooth security. The baseband layer may be above the radio layer in the Bluetooth protocol stack. The baseband layer may be implemented as a Link Controller, which works with the link manager for carrying out link level routines like link connection and power control. The baseband layer may also manage asynchronous and synchronous links, handles packets and execute paging and inquiry to access and inquire Bluetooth devices in the area. The bottommost layer, the radio layer, defines the requirements for a Bluetooth transceiver operating in the 2.4 GHz ISM band.

The Bluetooth controller 220 may process the received signals and communicate the processed signals to the host 210. The Bluetooth controller 220 may also enable transmitting Bluetooth signals to other Bluetooth devices. The Bluetooth controller 220 may process signals received from the host 210 before transmission to other Bluetooth devices. The host 210 and the Bluetooth controller 220 may communicate with each other. If, for example, the host 210 and the Bluetooth controller 220 are on different chips, they may communicate with each other via one or more links over the HCI 222.

In operation, a user of the Bluetooth enabled headset 200 may carry on a conversation with another user via, for example, the Bluetooth enabled cellular phone 104a. The Bluetooth controller 220 may communicate received digital voice data to the host 210. If, for example, the Bluetooth controller 220 is on a different chip than the host 210, communication between the Bluetooth controller 220 and the host 210 may be, for example, via the HCI 222. The host 210 may execute the Bluetooth software 214a to receive and process the digital voice data from the Bluetooth controller 220. For example, the host 210 may receive synchronous connection oriented (SCO) data packets and/or extended SCO (eSCO) data from the Bluetooth controller 220, and may process the packets. The processing may comprise converting the digital voice data to analog voice via the DAC 226, for example, in order to output the analog voice via the speaker 224.

A user of the Bluetooth enabled headset 200 may also speak into the microphone 230. The analog voice signal from the microphone 230 may be converted to digital voice data by, for example, the ADC 232. The digital voice data from the ADC 232 may be processed by the host 210. The digital voice data may be communicated as SCO and/or eSCO packets to the Bluetooth controller 220. The Bluetooth controller 220 may further process the digital voice data for transmission to the Bluetooth enabled cellular phone 104a.

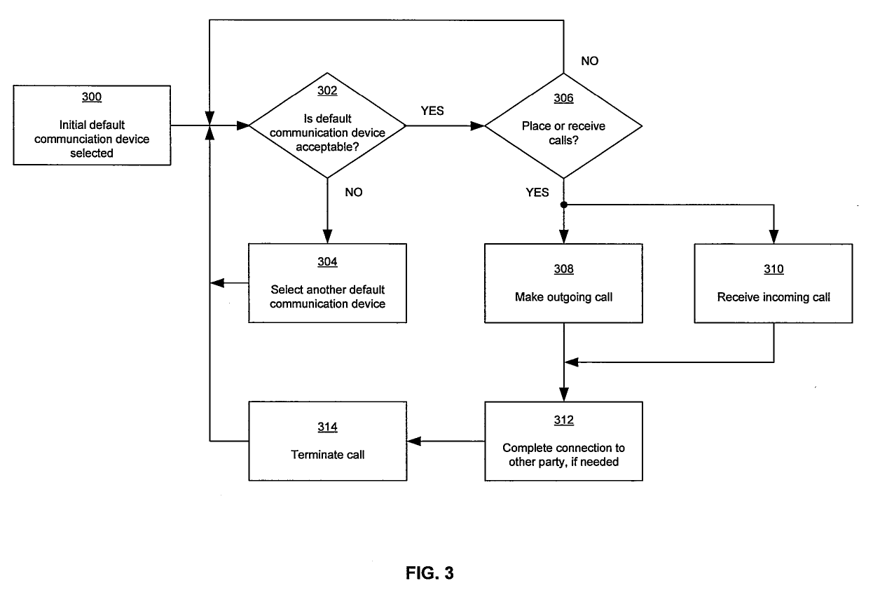

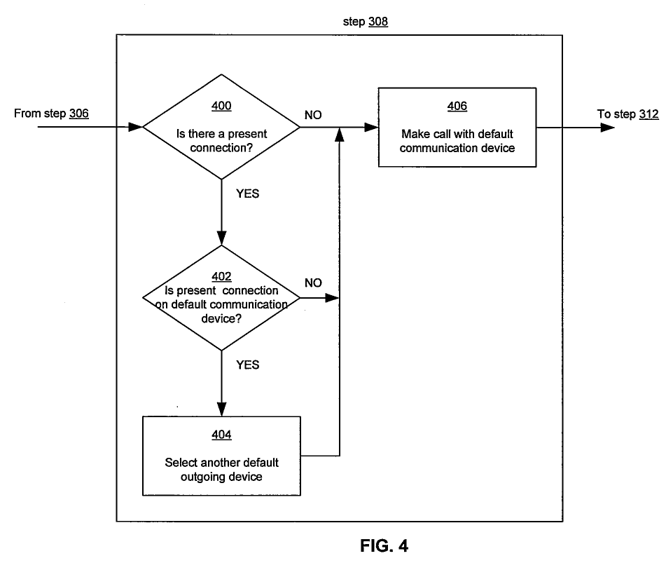

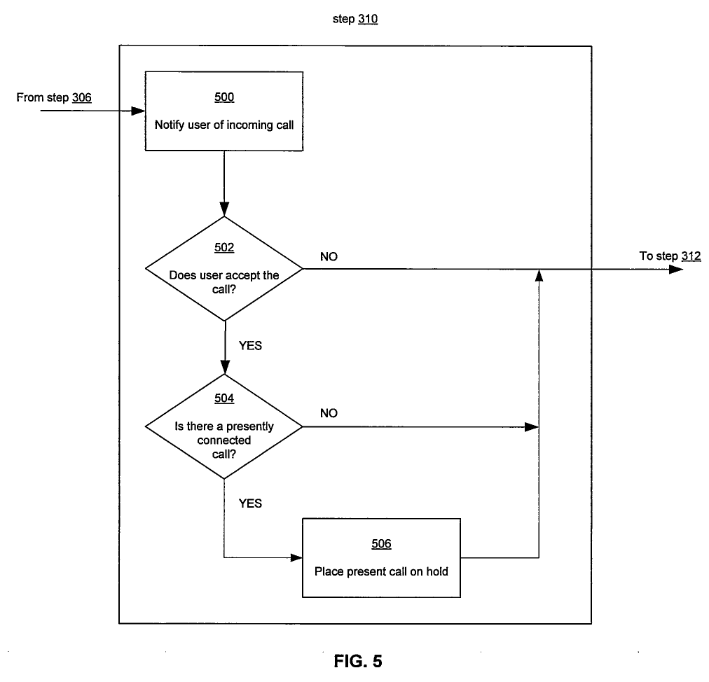

When the user of the Bluetooth enabled headset 200 initiates a call via one of a plurality of Bluetooth enabled wireless communication devices 104a, 104b, . . . , 104c, the user may be notified of the incoming call. The user may select one of the Bluetooth wireless communication devices 104a, 104b, . . . , 104c for placing the call by using the I/O device 234. This is described in more detail with respect to FIGS. 3 and 4. Additionally, a user of the Bluetooth enabled headset 200 may be presently connected to one of the Bluetooth enabled wireless communication devices 104a, 104b, . . . , 104c. If the user then receives another call via a second of the plurality of Bluetooth enabled wireless communication devices 104a, 104b, . . . , 104c, the user may be able to place the present call on hold, and answer the other call from the second of the Bluetooth enabled wireless communication devices 104a, 104b, . . . , 104c. This is described in more detail with respect to FIGS. 3 and 5. Various embodiments of the invention may allow a user to handle different numbers of calls. The total number of calls at a given time may be determined by, for example, the Bluetooth standard.

Various profiles may be specified for specific types of Bluetooth devices. For example, a hands-free profile for a Bluetooth device may be specified that defines minimum requirements that the Bluetooth device must support in a specific usage scenario. These requirements may define, for example, the end-user services and the features and procedures that the Bluetooth device must support to enable interoperability with peer devices. For example, Bluetooth enabled headset 200 may send commands to one of the Bluetooth enabled wireless communication devices 104a, 104b, . . . , 104c. The commands may comprise, for example, redialing a previously dialed number, dialing a number, rejecting an incoming call, and receiving an incoming call. The Bluetooth enabled wireless communication device 104a, 104b, . . . , 104c may then execute the command. The communication specified by the Bluetooth hands-free profile may occur via the Bluetooth protocol layers, some of which have been described above.

While an embodiment of the invention may have been described as comprising the host 210 communicating with a Bluetooth controller 220 via the HCI 222, the invention need not be so limited. For example, other embodiments of the invention may comprise the processor 212 and the memory 214 as part of the Bluetooth controller 220.

FIG. 3 is an exemplary flow diagram for supporting multiple connections, in accordance with an embodiment of the invention. Referring to FIG. 3, there is shown steps 300 to 314. In step 300, the Bluetooth enabled headset 200 may select an initial default communication device for outgoing calls. The selection of the initial default communication device may be design and/or implementation dependent. For example, the initial default communication device may be the first communication device that may have synchronized with the Bluetooth enabled headset 200.

In step 302, the user may determine whether the default communication device may be acceptable. If the user wishes to change the default communication device for outgoing calls, the next step may be step 304. Otherwise, the next step may be step 306. In step 304, the user may select another communication device as a default communication device. The method for changing the default communication device may be implementation dependent. For example, the I/O device 234 may comprise one or more buttons that may be used to select the default communication device. Holding a button down for different amounts of time may allow different functionalities, such as, for example, notifying that the next communication device may be ready for selection, and selecting a communication device as a default communication device.

In step 306, if a user decides to place or receive a call, the next step may be step 308 or step 310, respectively. Otherwise, the next step may be step 302. In step 308, the user may place an outgoing call. This step is described in more detail with respect to FIG. 4. In step 310, the user may receive an incoming call. This step is described with respect to FIG. 5. In step 312, either the outgoing call from the step 308 or the incoming call from the step 310 may be connected with the other party. In step 314, a user may terminate a call. The next step may be the step 302.

FIG. 4 is an exemplary flow diagram for initiating a call with one of a plurality of supported communication devices, in accordance with an embodiment of the invention. Referring to FIG. 4, there is shown steps 400 to 406. In step 400, which may be the next step after the step 306, the processor 212, for example, in the Bluetooth enabled headset 200 may determine whether there is a present connection that the user may be using for a call. If so, the next step may be the step 402. Otherwise, the next step may be the step 406.

In step 402, the processor 212 may determine whether the present connection may be via the default communication device. If so, the next step may be the step 404. Otherwise, the next step may be step 406. In step 404, the user may select another default communication device. This new default communication device may be used to place an outgoing call. Another embodiment of the invention may allow selecting another communication device for placing an outgoing call without making that communication device a default communication device. Accordingly, the default communication device may not be changed but an outgoing call may be placed using the non-default communication device.

In step 406, the user's outgoing call may be established via the default communication device. The user may, for example, use the I/O device 234 to place a call. For example, if the I/O device 234 comprises a button, pressing that button for a duration of time, such as, for example, 2 seconds, may redial the last number. If the I/O device 234 comprises a keypad, then a telephone number may be entered. Other embodiments of the invention may allow voice input for number selection. For example, the voice input may be via the microphone 230, and the commands may be a name associated with a number stored in the Bluetooth enabled headset 200 and/or a number stored in at least one of the wireless communication devices 104a, 104b, . . . , 104c. Accordingly, the user may establish calls to multiple parties via one or more communication devices.

For example, the user may place a call on hold, where that call may be established via one of the plurality of communication devices, such as, for example, the cellular phone 104a. The user may then make another call via, for example, the PDA 104b. Additionally, the user may also have access to features supplied by a specific communication service vendor. For example, a cellular phone company that provides service for the cellular phone 104a may enable call waiting and/or 3-way conference calls.

FIG. 5 is an exemplary flow diagram for receiving a call via at least one of a plurality of supported communication devices, in accordance with an embodiment of the invention. Referring to FIG. 5, there is shown steps 500 to 506. In step 500, the Bluetooth enabled headset 200 may notify the user of an incoming call. The notification may be via, for example, audio from the speaker 224, visual display on an LCD screen, and/or vibration of the Bluetooth enabled headset 200. The audio may comprise, for example, conversion to speech of text information regarding the incoming call that may have been communicated to the Bluetooth enabled headset 200 by one of the wireless communication devices 104a, 104b, . . . , 104c. For example, one of the wireless communication devices 104a, 104b, . . . , 104c may send text information to the Bluetooth enabled headset 200 regarding caller name and/or telephone number.

In step 502, the user may decide whether to accept the call or not. If the user decides not to accept the call, the next step may be step 312. The user may indicate whether to accept the call or not via the I/O device 234. For example, the user may press a button to indicate that the call be accepted. Other embodiments of the invention may allow a user to state, for example, using the words “Yes” or “No,” whether the user wishes to accept the call or not. If user decides to accept the call, the next step may be step 504. The Bluetooth enabled headset 200 may determine, for example, via the processor 212 whether there is a presently connected call. If there is, the next step may be step 312 where the call may be connected. Otherwise, the next step may be step 506 where the present call via one of the wireless communication devices 104a, 104b, . . . , 104c may be placed on hold. The next step may be step 312.

In accordance with an embodiment of the invention, aspects of an exemplary system may comprise the Bluetooth enabled headset 200 that may enable reception of a notification of an incoming call via one of the communication devices, for example, the communication devices 104a, 104b, . . . , 104c, when the Bluetooth enabled headset 200 is presently involved in an existing call via another of the communication devices 104a, 104b, . . . , 104c. The Bluetooth enabled headset 200 may provide audible, visible, and/or vibratory indication representative of the received notification. The Bluetooth enabled headset 200 may then allow the existing call to be put on hold, and the incoming call via the second of the plurality of Bluetooth devices may be answered by allowing a user to accept incoming call. If the user does not accept the incoming call, the existing call may not need to be put on hold.

The Bluetooth enabled headset 200 may prompt the user to accept or decline the incoming call. The prompt may be design, implementation, and/or user dependent. For example, the prompt may be an audible noise, speech output, and/or visible display. The speech and/or display may be generated in part from the information associated with the incoming call. For example, the information may comprise caller name and/or number, and/or stored information from the communication device 104a, 104b, . . . , 104c via which the incoming call may be communicated.

The Bluetooth enabled headset 200 may also allow initiation of an outgoing call via one of the communication device 104a, 104b, . . . , 104c, when the Bluetooth enabled headset 200 is currently engaged in an existing call via one of the communication device 104a, 104b, . . . , 104c. The outgoing call may be made via the communication device used for the existing call, for example, as in a 3-way conference call. The outgoing call may also be made via another of the communication devices 104a, 104b, . . . , 104c that is not used for the existing call. Various embodiments of the invention may allow automatically selecting of the communication devices 104a, 104b, . . . 104c as a default communication device for use in initiating outgoing calls. The automatically selected default communication device may also be changed by selecting another one of the communication devices 104a, 104b, . . . , 104c as a default communication device.

While the various embodiments of the invention may have been described for a Bluetooth enabled headset, the invention need not be so limited. Other embodiments of the invention may be used for Bluetooth headset and/or non-headset devices that may allow entry of a number to be dialed, display of caller ID information, and/or a communication device currently being used. For example, an embodiment of the invention may be used for a wireless speakerphone, such as, for example, a Bluetooth car kit, which may enable calls via the plurality of wireless communication devices 104a, 104b, . . . , 104c. Various embodiments of the invention may also be used for wireless devices that may use a wireless standard other than Bluetooth. Various embodiments of the invention may also enable data transmission as well as voice transmission.

Additionally, while an embodiment of the invention may have described one existing call when a second incoming call is received or an outgoing call is placed, the invention need not be so limited. For example, the number of present calls may be more than one when an incoming call is received or an outgoing call is placed.

Another embodiment of the invention may provide a machine-readable storage, having stored thereon, a computer program having at least one code section executable by a machine, thereby causing the machine to perform the steps as described above for method and system for a device that supports multiple connections.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for wireless communication, the method comprising:
enabling an active Bluetooth device to receive a notification of an incoming call via a second of a plurality of Bluetooth devices when said active Bluetooth device is engaged in an existing call via a first of said plurality of Bluetooth devices; and
generating by said active Bluetooth device an indication representative of said received notification.

2. The method according to claim 1, wherein said generated indication is at least one or more of the following: audible indication, visible indication, and vibratory indication.

3. The method according to claim 1, comprising enabling said active Bluetooth device to place said existing call on hold.

4. The method according to claim 1, comprising enabling said active Bluetooth device to answer said incoming call via said second of said plurality of Bluetooth devices.

5. The method according to claim 1, comprising enabling a user of said active Bluetooth device to select whether to accept or decline said incoming call via said second of said plurality of Bluetooth devices.

6. The method according to claim 5, comprising outputting speech as a prompt for said user for said accepting or said declining of said incoming call.

7. The method according to claim 6, wherein said output speech is generated at least in part from information communicated by said second of said plurality of Bluetooth devices.

8. The method according to claim 1, comprising enabling said active Bluetooth device to initiate an outgoing call via another one of said plurality of Bluetooth devices, when said active Bluetooth device is engaged in said existing call via said first of said plurality of Bluetooth devices.

9. The method according to claim 1, comprising automatically selecting one of said plurality of Bluetooth devices as a default Bluetooth device for initiating outgoing calls.

10. The method according to claim 1, comprising enabling changing said default Bluetooth device by selecting another one of said plurality of Bluetooth devices as a default communication device.

11. A machine-readable storage having stored thereon, a computer program having at least one code section for wireless communication, the at least one code section being executable by a machine for causing the machine to perform steps comprising:
enabling an active Bluetooth device to receive a notification of an incoming call via a second of a plurality of Bluetooth devices when said active Bluetooth device is engaged in an existing call via a first of said plurality of Bluetooth devices; and
generating by said active Bluetooth device an indication representative of said received notification.

12. The machine-readable storage according to claim 11, wherein said generated indication is at least one or more of the following: audible indication, visible indication, and vibratory indication.

13. The machine-readable storage according to claim 11, wherein the at least one code section comprises code for enabling said active Bluetooth device to place said existing call on hold.

14. The machine-readable storage according to claim 11, wherein the at least one code section comprises code for enabling said active Bluetooth device to answer said incoming call via said second of said plurality of Bluetooth devices.

15. The machine-readable storage according to claim 11, wherein the at least one code section comprises code for enabling a user of said active Bluetooth device to select whether to accept or decline said incoming call via said second of said plurality of Bluetooth devices.

16. The machine-readable storage according to claim 15, wherein the at least one code section comprises code for outputting speech as a prompt for said user to said accept or said decline said incoming call.

17. The machine-readable storage according to claim 16, wherein said output speech is generated at least in part from information communicated by said second of said plurality of Bluetooth devices.

18. The machine-readable storage according to claim 11, wherein the at least one code section comprises code for enabling said active Bluetooth device to initiate an outgoing call via another one of said plurality of Bluetooth devices, when said active Bluetooth device is engaged in said existing call via said first of said plurality of Bluetooth devices.

19. The machine-readable storage according to claim 11, wherein the at least one code section comprises code for automatically selecting one of said plurality of Bluetooth devices as a default Bluetooth device for initiating outgoing calls.

20. The machine-readable storage according to claim 11, wherein the at least one code section comprises code for enabling changing said default Bluetooth device by selecting another one of said plurality of Bluetooth devices as a default communication device.

21. A system for wireless communication, the system comprising:
an active Bluetooth device that enables reception of a notification of an incoming call via a second of a plurality of Bluetooth devices when said active Bluetooth device is engaged in an existing call via a first of said plurality of Bluetooth devices; and
said active Bluetooth device generating an indication representative of said received notification.

22. The system according to claim 21, wherein said generated indication is at least one or more of the following: audible indication, visible indication, and vibratory indication.

23. The system according to claim 21, wherein said active Bluetooth device enables placing said existing call on hold.

24. The system according to claim 21, wherein said active Bluetooth device enables answering of said incoming call via said second of said plurality of Bluetooth devices.

25. The system according to claim 21, wherein said active Bluetooth device enables a user to select whether to accept or decline said incoming call via said second of said plurality of Bluetooth devices.

26. The system according to claim 25, wherein said active Bluetooth device outputs speech as a prompt for said user to said accept or said decline said incoming call.

27. The system according to claim 26, wherein said output speech is generated at least in part from text communicated by said second of said plurality of Bluetooth devices.

28. The system according to claim 21, wherein said active Bluetooth device enables initiating an outgoing call via another one of said plurality of Bluetooth devices, when said active Bluetooth device is engaged in said existing call via said first of said plurality of Bluetooth devices.

29. The system according to claim 21, wherein said active Bluetooth device enables automatic selection of one of said plurality of Bluetooth devices as a default Bluetooth device for initiating outgoing calls.

30. The system according to claim 21, wherein said active Bluetooth device enables changing of said default Bluetooth device by selecting another one of said plurality of Bluetooth devices as a default communication device.
